(19) United States
(12) Patent Application Publication
(10) Pub. No.: US 2013/0035963 A1
(43) Pub. Date: Feb. 7, 2013

(54) SYSTEM AND METHOD FOR FINANCIAL TRANSACTIONS BETWEEN INSURANCE SERVICE PROVIDER AND MEDICAL SERVICE PROVIDER

(71) Applicant: Sheela Siddappa, Bangalore (IN)

(72) Inventor: Sheela Siddappa, Bangalore (IN)

(73) Assignee: Infosys Limited, Bangalore (IN)

(21) Appl. No.: 13/329,088

(22) Filed: Dec. 16, 2011

(30) Foreign Application Priority Data
Aug. 1, 2011 (IN) 2638/CHE/2011

(51) Int. Cl. G06Q 40/08

(52) U.S. Cl. 705/4

(57) ABSTRACT

The disclosure describes a method for prediction of functional dependencies between various factors involved in a payment given by an insurance service provider to a medical service provider for medical treatment of a patient comprising various steps like receiving input information wherein the input information comprises the basic factors involved in computation of the payment given by the insurance service provider to the medical service provider for the medical treatment of the patient. The received input information is then sorted based on some user selected basic factor and the sorted information is processed using data mining techniques to obtain the various functional dependencies between the basic factors. The determined functional dependencies are then displayed accordingly.

### FIELD

The present disclosure relates, generally, to the field of insurance re-imbursements, and in particular, to a method and system to determine medical insurance re-imbursements

### BACKGROUND

With the advent of technology, human beings have devised medical devices and facilities to cure themselves of diseases. These medical facilities are not affordable for all and also require a huge investment upfront from one who would want to use them. To solve this problem new methods of finance management have been devised; namely, insurances and medical reimbursements. Health insurance and medical reimbursement facilities work through the coordination between medical institutions and insurance service providers.

For each insurance policy used by a user in a medical institution, the insurance service provider pays the actual cost part of the actual cost incurred, to the medical institution. Insurance service providers and medical institutions work on an agreed method and agreed amount of payout. A formula with multiple factors is used to arrive at the final amount to be paid by an insurance service provider to a medical institution. This formula is based on various factors which includes but not limited to length of stay of the patient, type of disease, severity of disease. The diseases are categorized under a type of classification called as diagnosis related codes. Diagnosis related codes are used to categorize each disease into various classifications based on factors which include type of treatment required, severity of the disease, type of tests required, and length of hospital stay required. Currently the version of diagnosis related codes used is version 9. The codes are expected to be updated to version 10.

The formula used to arrive at the final amount paid by an insurance service provider to a medical institution is not available in the public domain. This formula is arrived at based on diagnosis related codes. Unless the formula is known, no prediction can be made on the final amount paid by an insurance service provider to a medical institution. The technology described herein comprises a system which derives the required formula. This formula will be useful to determine the functional dependencies between the various factors involved in calculating the amount paid by an insurance service provider to a medical institution for the medical treatment of a patient.

### SUMMARY

The disclosure provides for a method for prediction of functional dependencies between various factors involved in the payment given by an insurance service provider to a medical institution for the medical treatment of a patient. The method includes the step of receiving input information, wherein the input information comprises basic factors involved in the computation of the payment given by an insurance service provider to a medical institution for the medical treatment of a patient. Further, the method also includes the step of sorting input information using at least one user selected criteria, wherein the at least one user selected criteria comprises basic factors in the input information; determining, using the input information, functional dependencies between the basic factors involved in the payment given by an insurance service provider to a medical institution for the medical treatment of a patient; and displaying the predicted functional dependencies between the basic factors involved in the payment given by an insurance service provider to a medical institution for the medical treatment of a patient.

Further, according to one embodiment of the present invention, a system for prediction of functional dependencies between various factors involved in the payment given by an insurance service provider to a medical institution for the medical treatment of a patient is provided. The system includes an input module to receive input information, wherein the input information comprises basic factors involved in the computation of the payment given by an insurance service provider to a medical institution for the medical treatment of a patient; a sorting module to sort input information using at least one user selected criteria, wherein the at least one user selected criteria comprises basic factors in the input information; a calculation module to determine, using the input information, functional dependencies between the basic factors involved in the payment given by an insurance service provider to a medical institution for the medical treatment of a patient; and a display module to display the predicted functional dependencies between the basic factors involved in the payment given by an insurance service provider to a medical institution for the medical treatment of a patient.

### BRIEF DESCRIPTION OF THE DRAWINGS

These and other features, aspects, and advantages of the present invention will be better understood when the following detailed description is read with reference to the accompanying drawings in which like characters represent like parts throughout the drawings, wherein:

FIG. 1 illustrates an environment in which the technologies can be practiced, according to various embodiments;

FIG. 2 provides a list of parameters that are used in the method and system described in various embodiments of the present invention;

FIG. 3 is a flow diagram that gives the various steps and the sequences in which they are practiced;

FIG. 4 shows at the top level, various modules that are used in the system in which the invention is implemented; and

FIG. 5 illustrates the system in which the invention is implemented.

FIG. 6 is a system illustrating a generalized computer network arrangement, in one embodiment of the present technique.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

In general, in medical reimbursement systems, when a patient with medical insurance gets medical treatment from a medical service provider the cost of the treatment is borne by the medical insurance service provider. After the treatment, the insurance service provider pays the medical service provider on behalf of the patient for the medical treatment rendered.

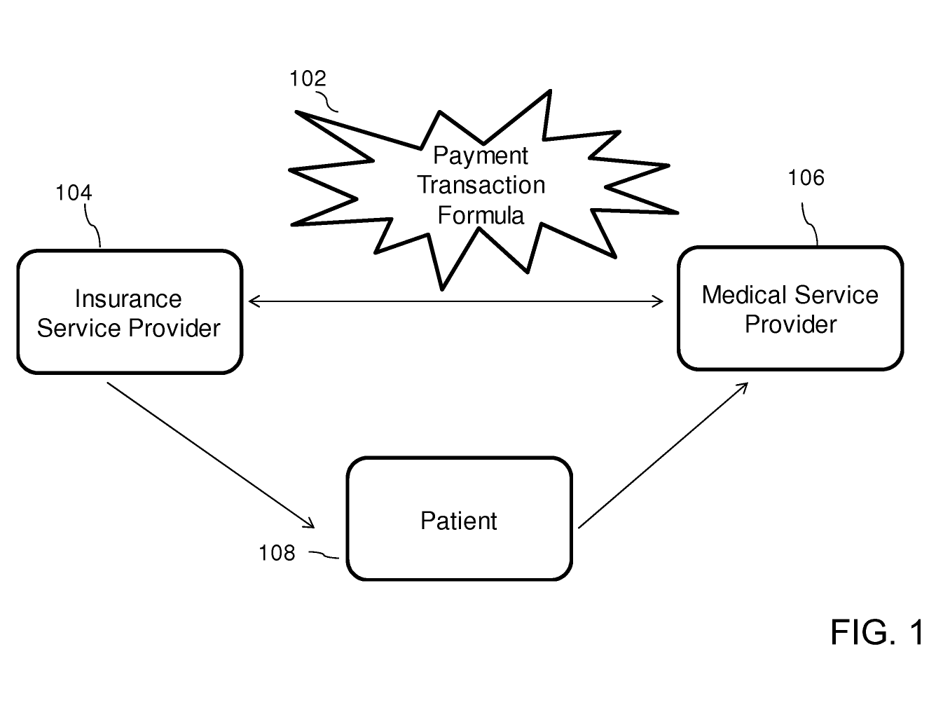

FIG. 1 gives a broad view of the various players involved in the above mentioned payment transaction. Typically a formula (102) is used by the insurance service provider (104) to arrive at an amount that needs to be paid to the medical service provider (106). Various basic factors, which include the kind of treatment received, the length of stay of the patent, are considered before arriving at the final payout amount. The technology described in the following paragraphs tries to build its own learning environment and thus arrive at the various functional dependencies between these basic factors considered for the determination of the formula.

The term functional dependencies refer to the influence of one entity on another in a mathematical relationship. For instance consider the relation,

x=y+1,

Where x and y are variables.

The concept of functional dependency in this case would refer to the effect on value of x when y changes. For every value of y, x becomes y+1. By extending this illustration to the technologies, we can define functional dependencies in this case to be the influence of various factors in the determination of the final amount paid by an insurance service provider to a medical service provider for the medical treatment of a past patient.

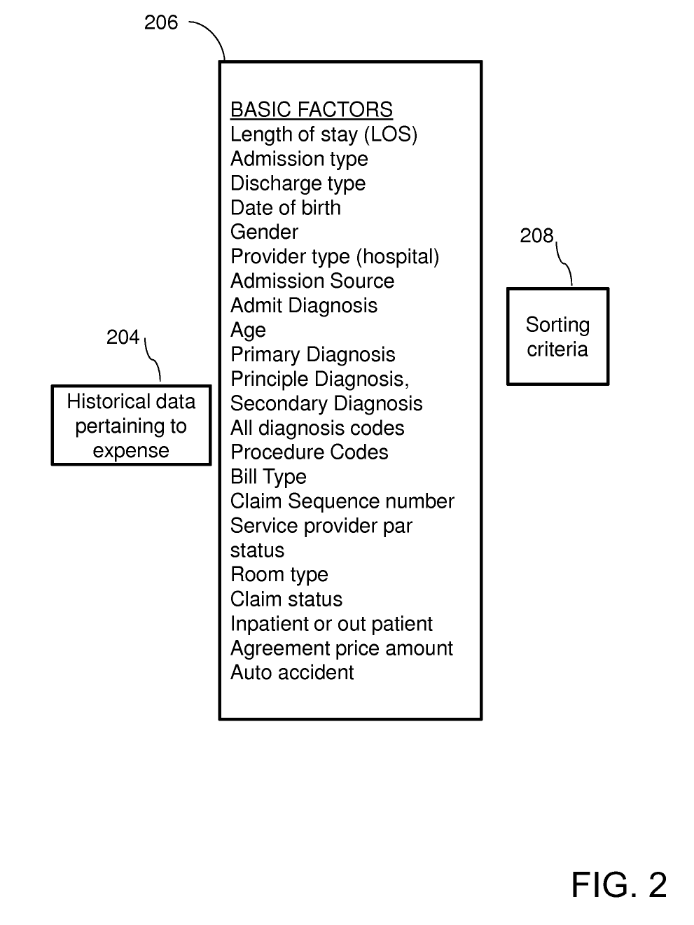

Any medical treatment provided for the patient by the medical service provider will be decided based on a plurality of basic factors such as Length of stay (LoS), Admission type, Discharge type, Date of birth, Gender, Provider type (hospital) and Diagnosis related codes (DRG), as shown in FIG. 2. Diagnosis related codes are a classification system used to group patient cases based on plurality of factors such as, but not limited to, principal diagnosis, age, procedures and gender. Historical data pertaining to the amount paid out by an insurance service provider to a medical service provider in the past is also given as an input. A sorting criterion is provided based on which the basic factors are sorted. The technologies can relate the final amount paid with basic factors by establishing functional dependencies between the basic factors. It is primarily important to establish functional dependencies to achieve consistency in payouts based on the similarity of factors between two cases that the insurance service provider may encounter.

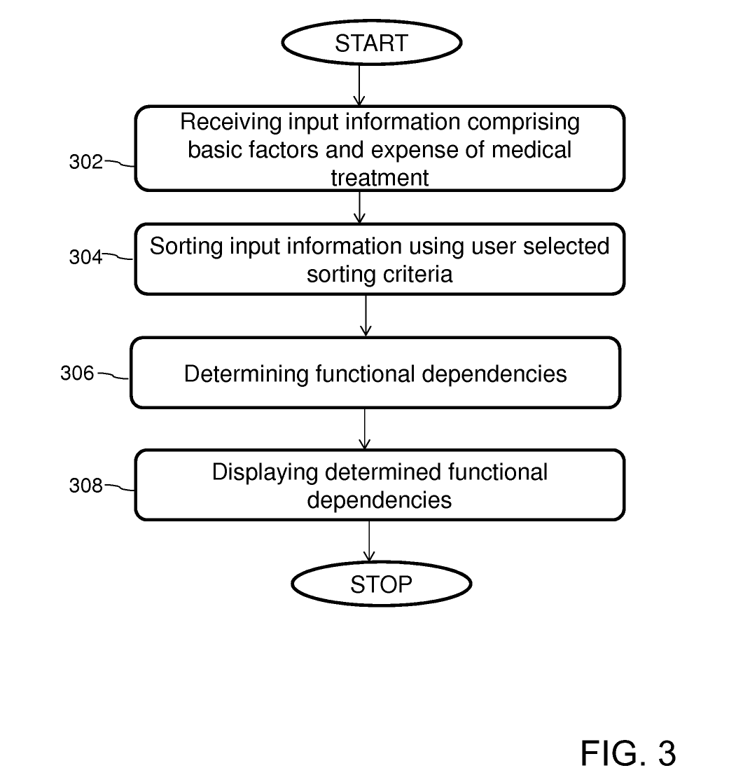

FIG. 3 is a diagram illustrating a method used for prediction of functional dependencies between various factors involved in a payment made by an insurance service provider to a medical service provider for medical treatment of a patient. At step 302 of the method, input information is received from a user. The input information, according to one embodiment of the present invention, includes historical data pertaining to the amount paid out by an insurance service provider to a medical service provider for the medical treatment of a past patient and the basic factors that are considered in the payout transaction (mentioned in FIG. 2). The received input information is sorted at step 304, based on at least one of the basic factors selected by the user. At step 306, functional dependencies between basic factors are determined. The functional dependencies between different basic factors involve establishing a mathematical relationship that connects the influence of the selected basic factor on all other basic factors considered. At step 308, the functional dependencies are displayed to the user. The functional dependencies can be used by the user to generate analyses pertaining to the influence/relation of/between different basic factors on the payment made by the insurance service provider.

According to one embodiment of the present invention, the basic factors considered for input include, but are not limited to, Length of stay (LoS), Admission type, Discharge type, Date of birth, Gender, and Medical Service Provider type (hospital). The user may sort the input information based on length of stay and may want to determine the influence of LoS on the payouts. In such a scenario, a functional dependency is calculated between LoS and other factors. According to another embodiment of the present invention, the sorted input information is used to calculated functional dependencies using known techniques that include, but are not limited to, Multivariate Adaptive Regression Splines (MARS), Neural Network, and Regression (Linear and nonlinear) analysis.

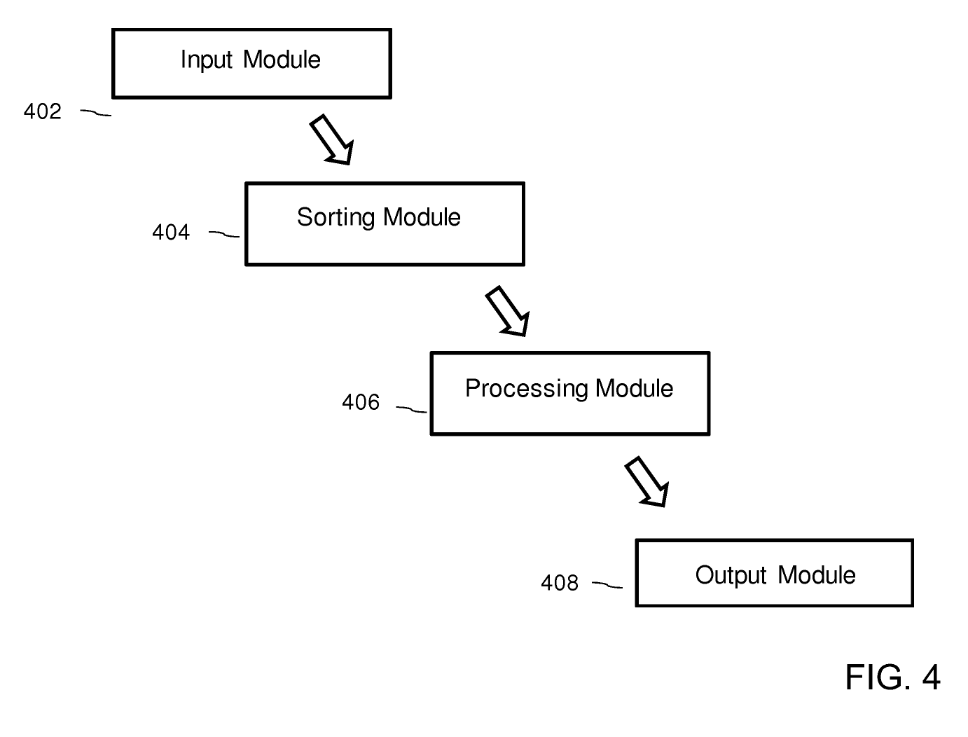

FIG. 4 shows the various modules that are used in the system for prediction of functional dependencies between various factors involved in a payment given by an insurance service provider to a medical service provider for medical treatment of a patient. The system includes an input module 402, a sorting module 404, a processing module 406, and an output module 408. The input module 402 receives input information from a user. The input information includes the basic factors such as but not limited to Length of stay (LoS), Admission type, Discharge type, Date of birth, Gender and Provider type (hospital) that are considered in the payout transaction between the insurance service provider and a medical service provider. In addition to the basic factors, diagnosis related codes and historical data pertaining to the amount paid by an insurance service provider to a medical service provider for the past medical treatment of a patient is also fed into the input module (402).

The input module receives the required data and sends it for sorting to the sorting module (404). Sorting is done based on user selected sorting criteria. Sorting criteria comprises selecting the basic factor based on which the functional dependencies involved in payout transaction between the insurance service provider and medical service provider are determined.

After the input information is sorted in the desired manner, it is send to the processing module 406 where the input data is acted upon by techniques such as but not limited to Multivariate Adaptive Regression Splines (MARS), Neural Network, and Regression (Linear and nonlinear) analysis. The resulting functional dependencies thus determined is then displayed using the output module (408). The display maybe in a format as desired by the user. Graphs and charts are preferred formats among several display options available.

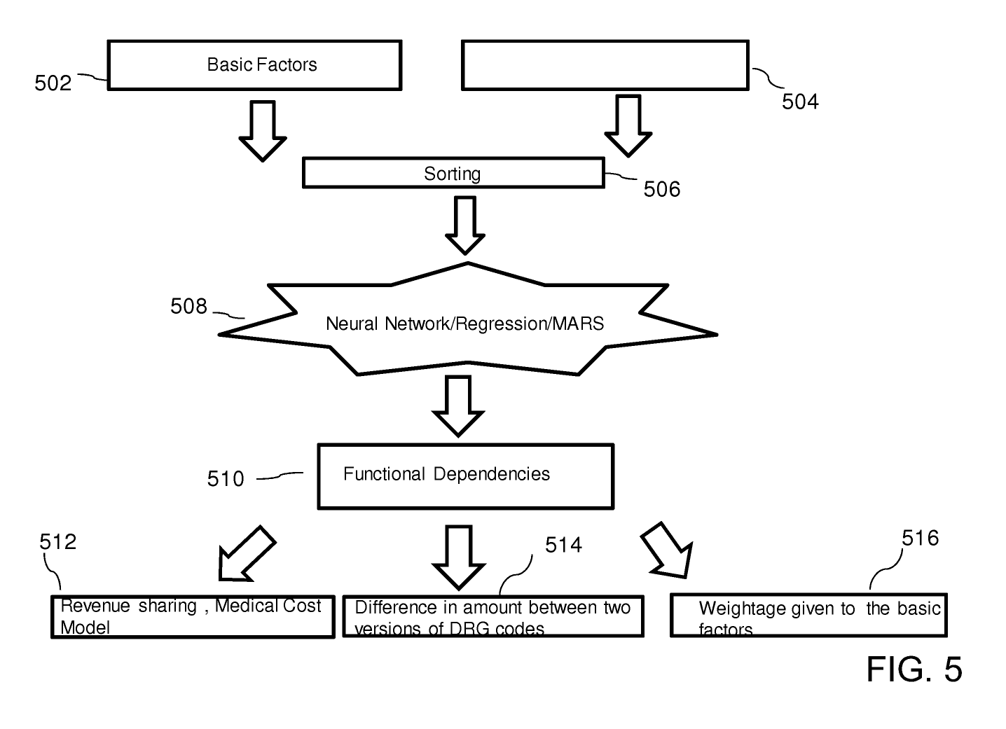

A preferred embodiment of the current system shown in FIG. 5 uses techniques such as neural networks, Regression, Multivariate adaptive regression splines and other data mining techniques to predict the functional dependencies involved in the calculation of expense paid by the insurance service provider to the medical service provider for the medical treatment of a patient.

Let us consider a particular instance of the technologies, determining the effect of change in version of a DRG code for a particular disease D1. Version V1 is the older version in which D1 is under DRG code C1. In the subsequent version of the DRG code V2, D1 is split between C1 and C2. The split of D1 into C1 and C2 is influenced by the length of stay of the patient. The difference in the payout amount between the two versions of the DRG code, V1 and V2 for the particular disease D1 is to be predicted.

The input information namely, the basic factors such as but not limited to Length of stay (LoS), Admission type, Discharge type, Date of birth, Gender and Provider type (hospital) and DRG codes that are considered in the payout transaction between the insurance service provider and a medical service provider and the final payout amount A1 that was paid by the insurance service provider to the medical service provider in version V1 for the treatment of disease D1 is fed into the input module (402).

Sorting module (404) comes into play as the input information is then sent for sorting. The input information is then sorted with DRG codes being the primary factor so that the functional dependencies between the DRG codes and the other basic factors can be presumed.

The sorted input information comprising the basic factors and the payout amount A1 are then fed into the processing module (406) employing data mining techniques such as a neural network. The neural network reads the data and trains itself to find the functional dependencies between DRG codes and the other factors under the condition that the a prescribed set of functional dependencies result in the final amount paid by the insurance service provider to the medical service provider which is equal to A1.

The functional dependencies F1 are obtained and from them, the basic factors that have a major influence on resulting in the payout amount equivalent to A1 for a particular version of DRG code V1 is determined. The output module (408) displays the determined functional dependencies in a user desired format.

The determined functional dependency/formulae are then fed into input module (402) again. Along with the functional dependency, input information comprising the basic factors such as but not limited to Length of stay (LoS), Admission type, Discharge type, Date of birth, Gender and Provider type (hospital) and DRG codes that are considered in the payout transaction between the insurance service provider and a medical service provider are also fed into the input module (402). The DRG codes considered in this case are version V2.

The input information is then sent to sorting module (404) and sorted on the basis of DRG codes with DRG codes being the primary factor.

The processing module (406) then acts upon the fed input information and for the given set of functional dependencies and the basic factors and the DRG codes, the final amount A2 that would be paid by the insurance service provider to the medical service provider for the medical treatment of disease D2 is predicted.

The difference between the two payout amount A1 and A2 in the two versions of the DRG codes V1 and V2 for the treatment of the disease D1 is determined using the above explained illustration.

In one of the embodiments of the present invention, the method involves feeding sorted basic factors to a neural network. The neural network 508 is trained on the basis of these input factors (502) to finally arrive at the expense paid by the insurance service provider to a medical service provider for the medical treatment of the particular patient under consideration. The different functional dependencies involved between the basic factors can thus be inferred. On the basis of the functional dependencies various analyses can be performed by the medical service provider and/or the insurance service provider. These analyses include, but are not limited to, the following:

The functional dependencies can be used to highlight the impact of change in diagnosis related code versions, based on the difference in the expenses paid by the insurance service provider to the medical service provider for the medical treatment of a patient. The functional dependencies can also be used to select patients based on their data depending on the criticality of each of the basic factors used in determining the final expense paid by the insurance service provider. The revenue shared between the insurance service provider and medical service provider when an insurance service provider pays the expense incurred for the medical treatment of a patient to a medical service provider can also be determined/analyzed using functional dependencies calculated. Medical service providers or Insurance service providers can build a strategy around medical costs by varying the functional dependencies between the basic factors used in the computation of the expense to be paid by an insurance service provider to a medical service provider.

Various other analyses can also be performed based on the functional dependencies between the basic factors. Thus the functional dependencies can be used to build a whole host of predictive mechanisms in the financial transactions between insurance service provider and a medical service provider.

### Exemplary Computing Environment

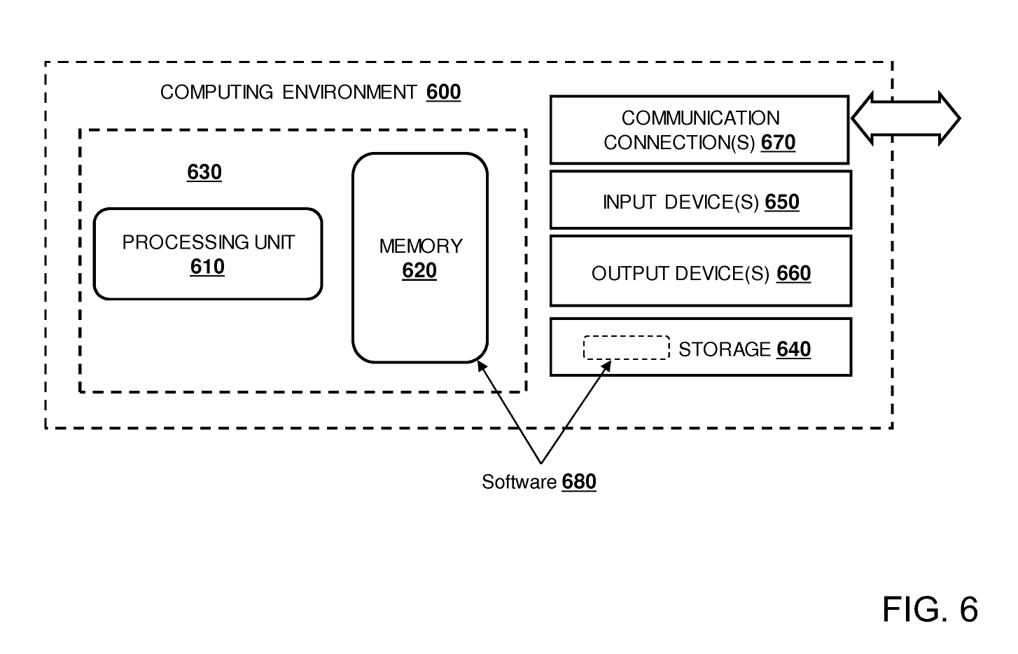

One or more of the above-described techniques may be implemented in or involve one or more computer systems. FIG. 6 illustrates a generalized example of a computing environment 600. The computing environment 600 is not intended to suggest any limitation as to scope of use or functionality of described embodiments.

With reference to FIG. 6, the computing environment 600 includes at least one processing unit 610 and memory 620. In FIG. 6, this basic configuration 630 is included within a dashed line. The processing unit 310 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. In some embodiments, the memory 620 stores software 680 implementing described techniques.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, CD-RWs, DVDs, or any other medium which may be used to store information and which may be accessed within the computing environment 600. In some embodiments, the storage 640 stores instructions for the software 680.

The input device(s) 650 may be a touch input device such as a keyboard, mouse, pen, trackball, touch screen, or game controller, a voice input device, a scanning device, a digital camera, or another device that provides input to the computing environment 600. The output device(s) 660 may be a display, printer, speaker, or another device that provides output from the computing environment 600.

The communication connection(s) 670 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 600, computer-readable media include memory 620, storage 640, communication media, and combinations of any of the above.

### Non-Transitory Computer-Readable Media

Any of the computer-readable media herein can be non-transitory (e.g., volatile or non-volatile memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

While the following description is presented to enable a person of ordinary skill in the art to make and use the invention, it is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What is claimed is:

1. A method for prediction of functional dependencies between various factors involved in a payment given by an insurance service provider to a medical service provider for medical treatment of a patient, the method comprising:
receiving input information, wherein the input information comprises basic factors involved in computation of the payment given by the insurance service provider to the medical service provider for the medical treatment of the patient;
sorting input information using at least one user selected criteria, wherein the at least one user selected criteria comprises basic factors from the input information;
determining, using the sorted input information, functional dependencies between the basic factors involved in the payment given by an insurance service provider to a medical service provider for the medical treatment of a patient; and
displaying the determined functional dependencies between the basic factors involved in the payment given by an insurance service provider to a medical service provider for the medical treatment of a patient.

2. The method as recited in claim 1 wherein the basic factors involved in the prediction of functional dependencies between various factors involved in the payment given by an insurance service provider to a medical service provider for the medical treatment of a patient comprise:
Length of stay (LoS), Admission type, Discharge type, Date of birth, Gender, Provider type (hospital), Admission Source, Admit Diagnosis, Age, Primary Diagnosis, Principle Diagnosis, Secondary Diagnosis, All diagnosis codes, Diagnosis related group (DRG) number, Procedure Codes, Bill Type, claim Sequence number, service provider par status, room type, claim status, Inpatient or out patient, Agreement price amount, Auto accident.

3. The method as recited in claim 1 wherein the basic factors involved in the prediction of the functional dependencies between various factors involved in the payment given by the insurance service provider to the medical service provider for the medical treatment of the patient further comprise:
historical data pertaining to the expense that was paid by the insurance service provider to the medical service provider for the medical treatment of a patient.

4. The method as recited in claim 2 further comprising:
using expense that was paid by the insurance service provider to the medical service provider for the medical treatment of a patient, to predict the differences in the expense incurred for the medical treatment of a patient between any two versions of diagnosis related grouping codes.

5. The method as recited in claim 2 further comprising:
using expense that was paid by the insurance service provider to the medical service provider for the medical treatment of a patient, to predict the revenue shared between the insurance service provider and medical service provider when an insurance service provider pays the expense incurred for the medical treatment of a patient to a medical service provider.

6. The method as recited in claim 2 further comprising:
using expense that was paid by the insurance service provider to the medical service provider for the medical treatment of a patient, to predict the weightage given to each of the basic factors involved in the computation of the expense of medical treatment of a past patient.

7. The method as recited in claim 2 further comprising:
using expense that was paid by the insurance service provider to the medical service provider for the medical treatment of a patient, to determine a strategy to build an efficient medical cost model by varying the functional dependencies between the basic factors used in the computation of the expense to be paid by an insurance service provider to a medical service provider.

8. The method as recited in claim 1 further comprising:
using techniques involving Multivariate Adaptive Regression Splines (MARS), Neural Network, and Regression (Linear and nonlinear) analysis.

9. A system for prediction of functional dependencies between various factors involved in a payment given by an insurance service provider to a medical service provider for medical treatment of a patient, the system comprising:
an input module to receive input information, wherein the input information comprises basic factors involved in the computation of the payment given by an insurance service provider to a medical service provider for the medical treatment of a patient;
a sorting module to sort input information using at least one user selected criteria, wherein the at least one user selected criteria comprises basic factors in the input information;
a processing module used to determine, using the input information, functional dependencies between the basic factors involved in the payment given by an insurance service provider to a medical service provider for the medical treatment of a patient; and
an output module to display the predicted functional dependencies between the basic factors involved in the payment given by an insurance service provider to a medical service provider for the medical treatment of a patient.

10. The system as recited in claim 9 wherein the basic factors involved in the prediction of functional dependencies between various factors involved in the payment given by an insurance service provider to a medical service provider for the medical treatment of a patient comprise:
Length of stay (LoS), Admission type, Discharge type, Date of birth, Gender, Provider type (hospital), Admission Source, Admit Diagnosis, Age, Discharge Status, Principle Diagnosis, Secondary Diagnosis, All diagnosis codes, Diagnosis related grouping codes, Procedure Codes, Bill Type, claim Sequence number, service provider par status, room type, claim status, Inpatient or out patient, Provider type, Agreement price amount, Auto accident.

11. The system as recited in claim 9 wherein the basic factors involved in the prediction of the functional dependencies between various factors involved in the payment given by the insurance service provider to the medical service provider for the medical treatment of the patient further comprise:
historical data pertaining to expense that was paid by the insurance service provider to the medical service provider for the medical treatment of a patient.

12. The system as recited in claim 9 further comprising using expense that was paid by the insurance service provider to the medical service provider for the medical treatment of a patient, to predict the differences in the expense incurred between any two versions of diagnosis related grouping codes.

13. The system as recited in claim 9 further comprising using expense that was paid by the insurance service provider to the medical service provider for the medical treatment of a patient, to predict the revenue shared between the insurance service provider and medical service provider when an insurance service provider pays the expense to a medical service provider.

14. The system as recited in claim 9 further comprising using expense that was paid by the insurance service provider to the medical service provider for the medical treatment of a patient, to predict the weightage given to each of the basic factors involved in the computation of the expense of medical treatment of a past patient.

15. The system as recited in claim 9 further comprising using expense that was paid by the insurance service provider to the medical service provider for the medical treatment of a patient, to determine a strategy to build an efficient medical cost model by varying the functional dependencies between the basic factors used in the computation of the expense to be paid by an insurance service provider to a medical service provider.

16. The system as recited in claim 9 further comprising using techniques involving Multivariate Adaptive Regression Splines (MARS), neural network, and Regression analysis.

17. A computer program product for prediction of functional dependencies between various factors involved in a payment given by an insurance service provider to a medical service provider for medical treatment of a patient, the computer program product comprising:
instructions to receive input information, wherein the input information comprises basic factors involved in the computation of the payment given by an insurance service provider to a medical service provider for the medical treatment of a patient;
instructions to sort input information using at least one user selected criteria, wherein the at least one user selected criteria comprises basic factors in the input information;
instructions to determine, using the input information, functional dependencies between the basic factors involved in the payment given by an insurance service provider to a medical service provider for the medical treatment of a patient; and
instructions to display the predicted functional dependencies between the basic factors involved in the payment given by an insurance service provider to a medical service provider for the medical treatment of a patient.

18. The computer program product as recited in claim 17 wherein the basic factors involved in the prediction of functional dependencies between various factors involved in the payment given by an insurance service provider to a medical service provider for the medical treatment of a patient comprise:
Length of stay (LoS), Admission type, Discharge type, Date of birth, Gender, Provider type (hospital), Admission Source, Admit Diagnosis, Age, Discharge Status, Principle Diagnosis, Secondary Diagnosis, All diagnosis codes, Diagnosis related grouping codes, Procedure Codes, Bill Type, claim Sequence number, service provider par status, room type, claim status, Inpatient or out patient, Provider type, Agreement price amount, Auto accident.

19. The computer program product as recited in claim 17 wherein the basic factors involved in the prediction of the functional dependencies between various factors involved in the payment given by the insurance service provider to the medical service provider for the medical treatment of the patient further comprise:
historical data pertaining to expense that was paid by the insurance service provider to the medical service provider for the medical treatment of a patient.

20. The computer program product as recited in claim 17 using expense that was paid by the insurance service provider to the medical service provider for the medical treatment of a patient, to predict the differences in the expense incurred between any two versions of diagnosis related grouping codes.

21. The computer program product as recited in claim 17 further comprising using expense that was paid by the insurance service provider to the medical service provider for the medical treatment of a patient, to predict the revenue shared between the insurance service provider and medical service provider when an insurance service provider pays the expenses to a medical service provider.

22. The computer program product as recited in claim 17 further comprising using expense that was paid by the insurance service provider to the medical service provider for the medical treatment of a patient, to predict the weightage given to each of the basic factors involved in the computation of the cost of medical treatment of a past patient.

23. The computer program product as recited in claim 17 further comprising using expense that was paid by the insurance service provider to the medical service provider for the medical treatment of a patient, to determine a strategy to build an efficient medical cost model by varying the functional dependencies between the basic factors used in the computation of the expense to be paid by an insurance service provider to a medical service provider.

24. The computer program product as recited in claim 17 further comprising using techniques involving Multivariate Adaptive Regression Splines (MARS), neural network, and Regression analysis.
